(19) United States
(12) Patent Application Publication
(10) Pub. No.: US 2025/0098660 A1
(43) Pub. Date: Mar. 27, 2025

(54) CROP INPUT APPLICATION APPARATUS, SYSTEMS AND METHODS

(71) Applicant: MA Industries, LLC, Morton, IL (US)

(72) Inventors: Gregg Sauder, Morton, IL (US); Timothy Sauder, Morton, IL (US); Justin Koch, Morton, IL (US); Nowell Moore, Morton, IL (US); Reid Aberle, Morton, IL (US); Tyler Nafziger, Morton, IL (US); Conner Hesterberg, Morton, IL (US); Jonathan Welte, Morton, IL (US); Kyle Waremburg, Morton, IL (US); Steven Nuest, Morton, IL (US); Talon Sauder, Morton, IL (US); Phil Baurer, Morton, IL (US)

(21) Appl. No.: 18/727,259

(22) PCT Filed: Jan. 9, 2023
(86) PCT No.: PCT/US2023/060338

§ 371 Date: Jul. 8, 2024

Related U.S. Application Data
(60) Provisional application No. 63/373,707, filed on Aug. 27, 2022.
(60) Provisional application No. 63/266,563, filed on Jan. 7, 2022.

(51) Int. Cl. A01M 7/00

(52) U.S. Cl. CPC A01M 7/005; A01M 7/0042; A01M 7/0089

(57) ABSTRACT

An application vehicle applies agricultural inputs to a crop supplied to the vehicle through a conduit. A fluid distribution system including a manifold is used to supply agricultural input to application devices.

### BACKGROUND

The present disclosure relates to application vehicle that apply agricultural inputs to a crop supplied to the vehicle through a conduit. Inputs may be liquids, dry particulate, or a mix of both. The conduit may be a constant diameter throughout its length, or it may vary. The conduit may be stored on a reel carried by the vehicle.

### BRIEF DESCRIPTION OF THE DRAWINGS

FIG. 1 is a schematic side view of an application vehicle.

FIG. 2 is a side view of a flow distribution system.

FIG. 3 is a top view of a flow distribution system.

FIG. 4 is an internal view of an orifice manifold.

FIG. 5 is a schematic view of a distribution system connecting an orifice manifold and application points.

FIG. 6 is a schematic cross-sectional view of an air ingestion chamber.

FIG. 7 is a cross-sectional view of a splitter.

FIG. 8 is a cross-sectional view of a splitter extension.

FIG. 9 is a side view of a conduit management assembly.

FIG. 10 is a top view of the conduit management assembly of FIG. 9.

FIG. 11 is a close-up, side view of the conduit management assembly of FIG. 9.

FIG. 12 is a close-up, side view of the conduit management assembly of FIG. 9 from an opposing side.

FIGS. 13-19 are schematic views of a vehicle progressing along a path.

FIG. 20 is a close-up view of an angle sensor connected to an arm.

FIG. 21 is a plan view of an application vehicle having multiple booms.

FIG. 22 is a perspective view of a manifold assembly mountable to a vehicle.

FIG. 23 is a sectional view of the manifold assembly of FIG. 22.

FIG. 24 is a bottom view of the manifold assembly of FIG. 22.

FIG. 25 is a sectional view of a control assembly configured to control flow from a manifold assembly.

FIG. 26 is a schematic view of different application devices.

FIG. 27 is a side view of a conduit management assembly.

FIG. 28 is a side view of a conduit management assembly.

FIG. 29 is a side view of a conduit management assembly.

FIG. 30 is a side view of the conduit management assembly of FIG. 30 from an opposite side.

FIG. 31 is a perspective view of a portion of a conduit management assembly.

FIG. 32 is a schematic view of a vehicle progressing along a path.

FIG. 33 is a perspective view of a portion of a conduit management assembly.

FIG. 34 is a schematic view of a sensor for a conduit management assembly.

FIG. 35 is an end view of an example gripping device.

FIG. 36 is a side view of a gripping device.

FIG. 37 is an end view of an example gripping device.

FIG. 38 is a side view of a conduit management assembly.

FIG. 39 is a side view of the conduit management assembly of FIG. 38 from an opposite side.

### DESCRIPTION

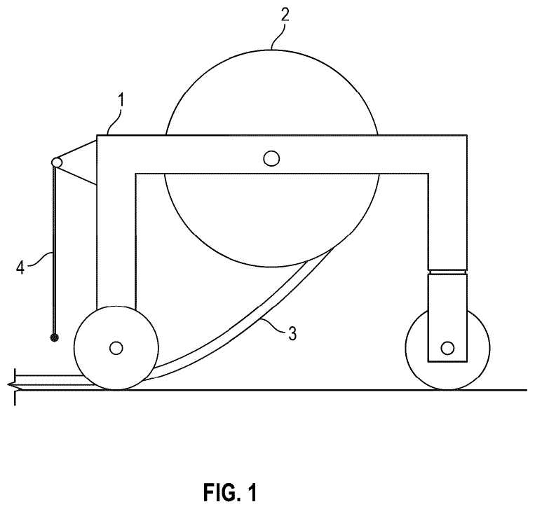

An application vehicle (1) is schematically illustrated in FIG. 1. In one embodiment, the vehicle applies agricultural inputs to a crop supplied to the vehicle through a conduit (3). Inputs may be liquids, dry particulate in an air stream, or a mix of both. The conduit (3) may be a constant diameter throughout its length, or the diameter may vary. The conduit (3) may be stored on a reel (2) carried by the vehicle (1), where the conduit (3) can be extended from or retracted onto the reel (2). The vehicle may be driven by electric motors and supplied by various power sources such as electrical power, combustible engine and the like. Agricultural inputs may be applied to the crops through nozzles, drops, or other application devices (4) positioned on the vehicle (1). A control system or assembly can receive signals from sensors on the vehicle (1) and control elements on the vehicle (1) as described herein.

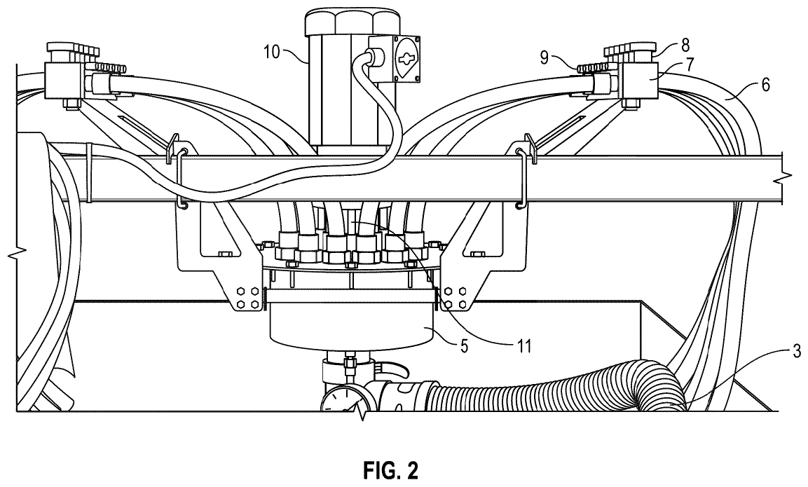

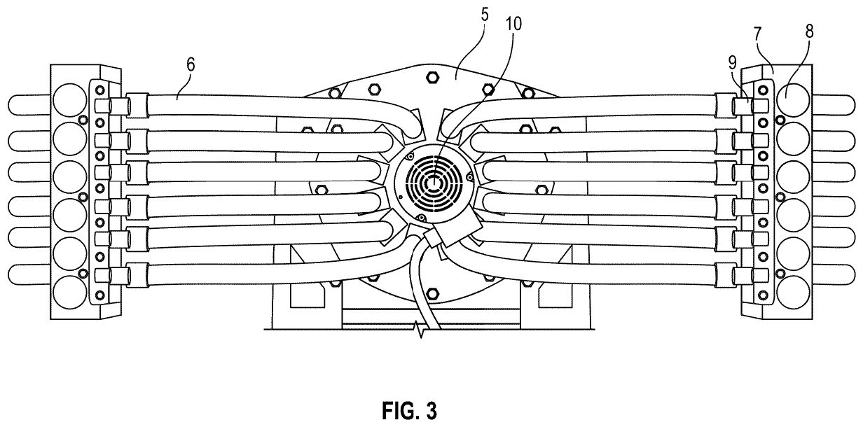

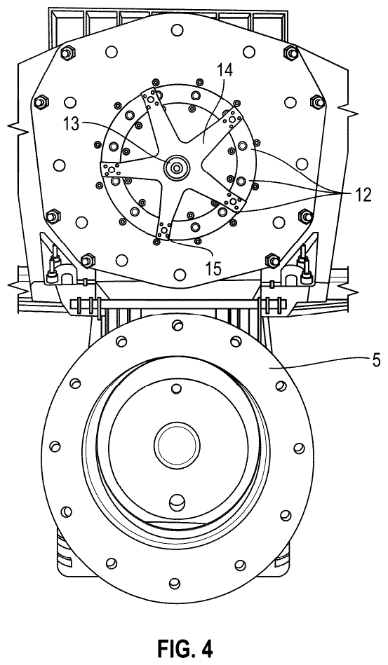

The vehicle (1) can employ a flow distribution system, one example of which is shown in FIGS. 2 and 3. In this embodiment, an orifice manifold (5) may be fluidly coupled to receive flow from the conduit (3) and divide the flow through two or more orifices (12, see FIG. 4) (i.e., a plurality) from which flow continues through individual tubes or hoses (6) to the application devices (4) illustrated in FIG. 1. In one embodiment, the flow may be passed through an air ingestion chamber (7) before it reaches the application device (4). A check valve (8) may be used to allow air to enter the chamber but prevent flow from escaping. A pressure/vacuum sensor (9) may be positioned between the orifice and the air ingestion chamber to measure the pressure or vacuum in each individual tube. A motor (10) and gearbox (11) may be used to turn an agitation blade inside the orifice manifold to stir any solids that are being carried in the flow and clear off any orifice plugged by solids. When applying a fluid containing a percentage of solids, the flow path should get progressively larger in diameter or stay the same from the beginning to the end of the flow path. Any reduction in diameter of the flow path can increase the frequency of plugging within the tubes (6).

FIG. 4 shows a view of the internal components of the orifice manifold (5). The manifold (5) has a cover removed and flipped vertically, showing internal components and a base defining cavity is shown below the cover. During use, the cover is positioned upon the base and the internal components are in the cavity. In one embodiment, orifices (12) are positioned in a ring around a center axis. A shaft (13) from the gearbox passes through the center axis to turn an agitation or shear blade (14). A hole or slot (15) may be positioned in each arm of the agitation blade to reduce time that flow is blocked from passing through the orifice (12). Reducing the time flow is blocked can result in less violent starting and stopping of the flow. In one embodiment, a wear pad (not shown) may be mounted between the agitation blade (14) and an orifice surface defining each orifice. The agitation blade (14) may be mounted a small distance away from the orifice surface when flow is passing through the manifold. Force of the flow into orifice manifold (5) may flex the agitation blade (14) to press it against the orifices (12) to clear any accumulation of solid material. The agitation blade (14) may alternatively be mounted with a preload against the orifice surface to ensure it maintains sufficient contact therewith when clearing solids.

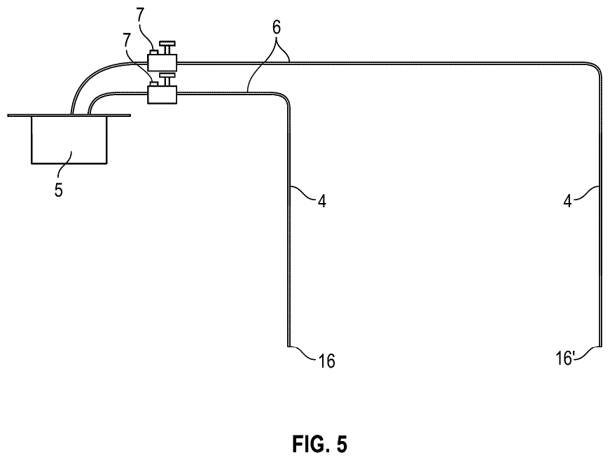

An example distribution system is shown schematically in FIG. 5, wherein liquid flow passes from the orifice manifold (5) through two individual tubes (6). The upper tube (6) in FIG. 5 is longer than the lower tube (6). Both tubes (6) are suspended above the ground during use and the application device (4) is a drop terminating at an application point (16) near or on the surface of the ground. The flow of liquid down the drop will create siphoning and cause a suction on each individual tube. Due to the shorter length, more suction will be produced at an inlet (i.e., the connection between the respective orifice (12) and the tube (6)) of the short tube versus the long tube despite the length of the application devices being the same. This difference in suction will cause more flow in the short tube versus the long tube. An air ingestion chamber (7) is placed in each individual tube to balance the flow between the two tubes.

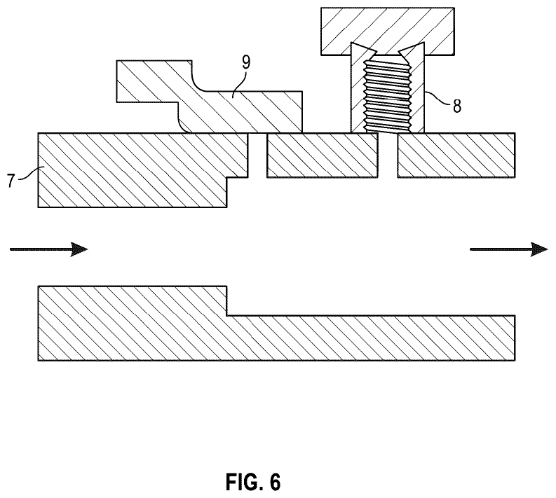

A schematic cross section of the air ingestion chamber (7) is shown in FIG. 6. Flow from the orifice manifold (5) passes through the chamber (7) from the orifice manifold (5) and then continues to the application device (4). In the embodiment illustrated, a pressure/vacuum sensor (9) is coupled to the chamber to measure the vacuum created in the chamber as it expands. Consistent vacuum levels as measured by pressure/vacuum sensor (9) in each individual tube indicates uniform flow at each application device (4). A plugged application device is also detectable. Flow then passes by a one-way valve or a check valve (8) coupled with the air ingestion chamber (7). Different suction from any differing length of individual tube (6) will produce a different vacuum in each air ingestion chamber (7). This vacuum opens each check valve (8) more or less to equalize the flow in all individual tubes. The check valve (8) is operable to control flow through the ingestion chamber (7). As the check valve (8) is pulled open further or more often, more air is ingested into the individual tube and the ratio of liquid and air increases. In a short tube with greater pull, more air is ingested, and the opposite is true in a long tube. In this way, liquid flow to all application devices is equalized.

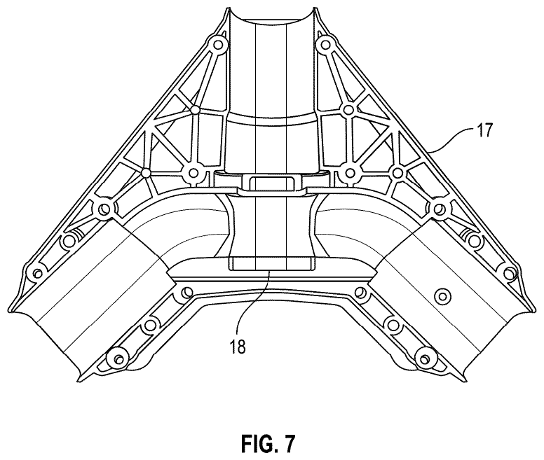

In some embodiments, as illustrated in FIG. 7, an application device is a drop connected to the end of an individual tube. As shown in cross section, a splitter (17) may be connected to the bottom of the drop to split the liquid flow into two application points. Flow enters from the drop at the top of the splitter. Flow then impacts a generally flat bottom wall (18) of a chamber and is turned back on itself. This arrangement improves the equal division of fluid to each side of the splitter (17). Split flow then travels out each side of the splitter to the application point.

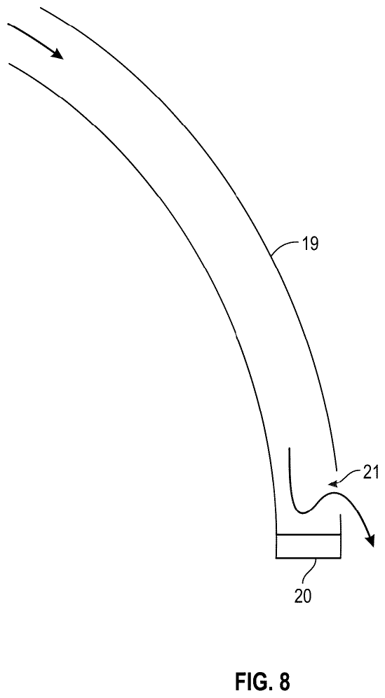

As shown in the cross section of FIG. 8, a splitter extension (19) may be used to both widen and lower the application point from the splitter. Flow enters at the top of the extension and travels to the end where it impacts a plug (20). The flow is then diverted back on itself and through the outlet (21) on one side of the extension (19). This diversion reduces energy in the fluid that could otherwise cause damage. For example, a stream of high energy fluid may cut the soil and cause it to be displaced or damage growing plants by tearing leaves or uprooting them. The outlet (21) may be a circle, triangle, oval or other shape to change the shape of the liquid flow as it exits the extension (19).

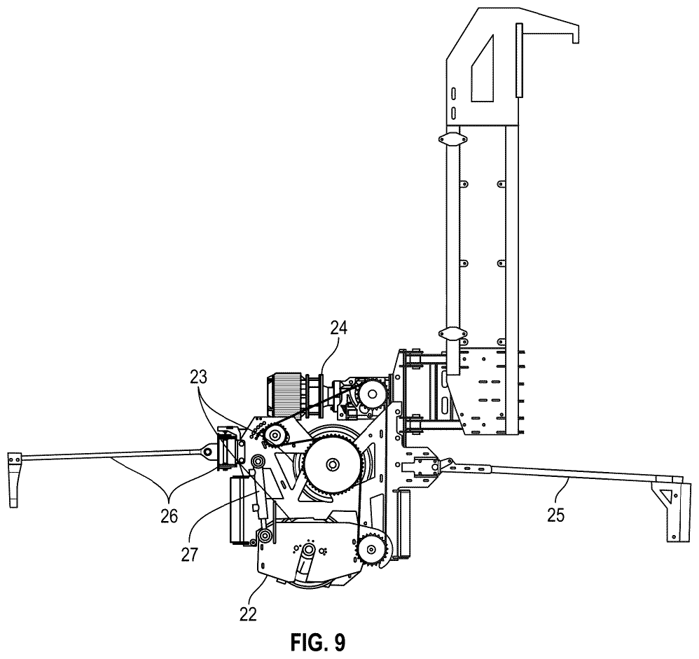

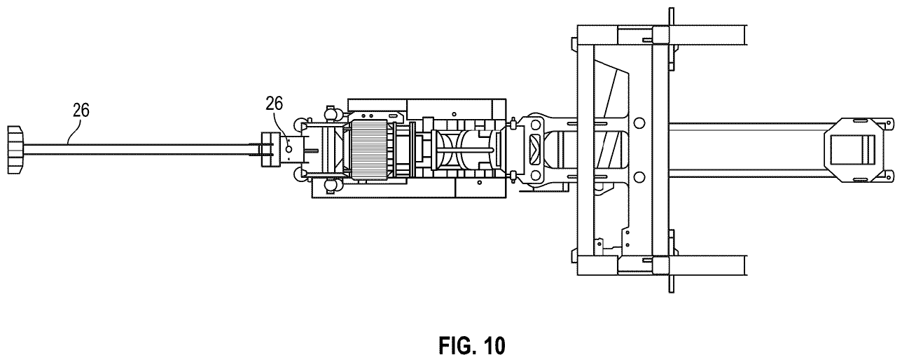

Vehicle (1) can also employ a conduit management assembly including a conduit dispenser to dispense conduit (3) from reel (2) and retract conduit (3) onto reel (2). For example, as shown in FIGS. 9 and 10, a conduit dispenser (22) may be used to control the amount of conduit dispensed or retracted by the vehicle (1) as it moves. Gripping devices (23), turned by a motor and gearbox or other rotational actuator (24), grip the conduit therebetween and rotate at or about ground speed based on one or more inputs including but not limited to GPS, Steering Angle, Wheel Speeds, Accelerometers, Gyros, Radar, or other speed inputs of vehicle (1). The conduit (3) then is pulled from the reel (2) while the vehicle drives forward by the gripping devices (23) lifting a conduit tension sensor (25) above its target tension position. In response to the lifting, conduit tension sensor (25) can send a signal to the reel (2) to spin faster to lower tension in the conduit (3) while also meeting a desired dispensing rate. A conduit angle sensor (26) may be used to change the speed of the gripping devices (23) higher or lower based on the angular position of the conduit relative to the vehicle (1) as measured by the angle sensor (26). One or more linear actuators (27) such as hydraulic cylinders may be used to change the distance between the gripping devices (23) or controlled to change the force applied on the conduit (3) by the gripping devices (23).

Alternatively, springs may be used in place of actuators to apply a force on the conduit. Optionally, a cleaning system may be included to maintain consistent grip by each gripping device (23) on the conduit. The conduit (3) may be passed through a ring of brushes or rubber wipers positioned to remove material from the surface of the conduit. In another embodiment, liquid may be applied to the surface of one or more of the gripping devices to clean them as the rotate and grip the conduit. This cleaning will remove substances and other material from both the gripping devices (23) and the conduit (3). The liquid may be pumped from a tank carried on the vehicle or sourced directly from the conduit (3) as the conduit (3) supplies the application system on the vehicle. The liquid sourced from the conduit may be applied directly or filtered and then applied to the gripping devices (23).

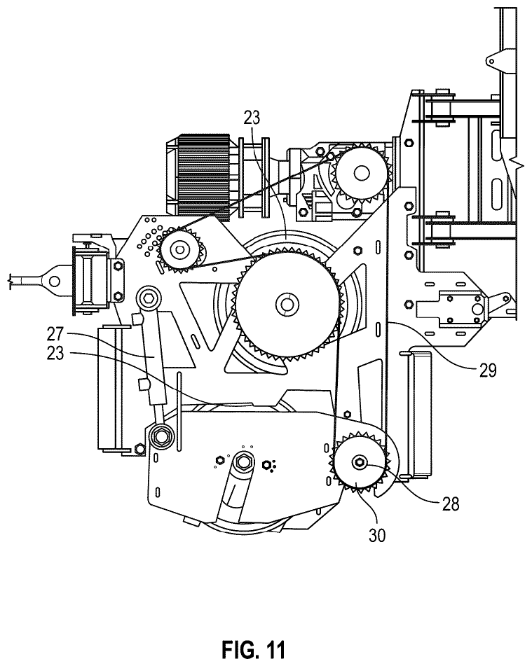

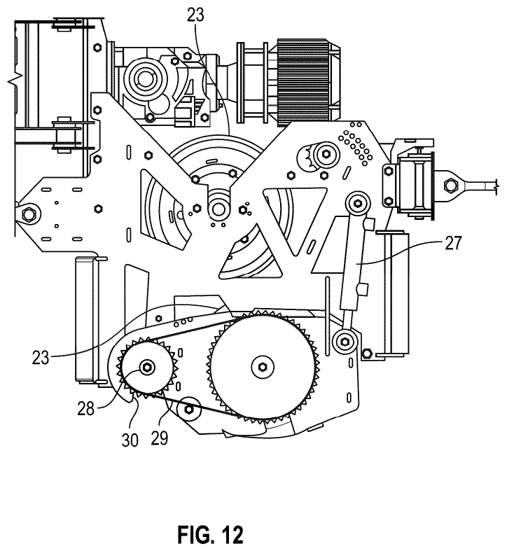

Referring additionally to FIGS. 11 and 12 (close-up side views on opposite sides of the conduit dispenser (22)), a pivot point (28) is provided to allow the linear actuators (27) to change the distance between the gripping devices (23). Chains, direct drive motors, or gears may be used to translate a rotational output from an actuator (e.g., an electric motor) to drive the gripping devices (23). In one embodiment, chains (29) are used and a drive shaft with sprockets (30) passes through the pivot point (28) so that the distance between the gripping devices (23) may be changed while maintaining the ability to drive the gripping devices (23). In another embodiment, gears are used and a gear is positioned to rotate at the pivot point (28) for the same purpose. The linear actuators (27) may be controlled to maintain a gripping force between the gripping devices. For example, a hydraulic pressure sensor may be used to measure the force applied by the linear actuators (27) through the gripping devices (23) onto the conduit (3). A target pressure may be set and that pressure maintained as the shape of the conduit or other factors vary. The linear actuators (27) may also be controlled to maintain a set distance between the gripping devices (23). In one embodiment, an angle sensor may be mounted to the pivot point (28) and a consistent angle maintained by the linear actuators resulting in a consistent distance between the gripping devices. In another embodiment, a closed position stop may be used to limit the distance between the gripping devices (23) and sufficient force applied by the linear actuators (27) to keep the frame held against the stop. The linear actuators (27) may be used to open the distance between the gripping devices (23) so they are disengaged from the conduit and no longer control its movement. In a further embodiment, a clutch may be included in a drive system for the gripping devices, allowing the gripping devices to be rotationally disengaged and freely spin with the movement of the conduit and then reengaged to control the movement of the conduit through the conduit dispenser (22). Linear actuators and a clutch may be used together to both open the distance between the gripping devices and to allow them to freely spin if they contact the conduit.

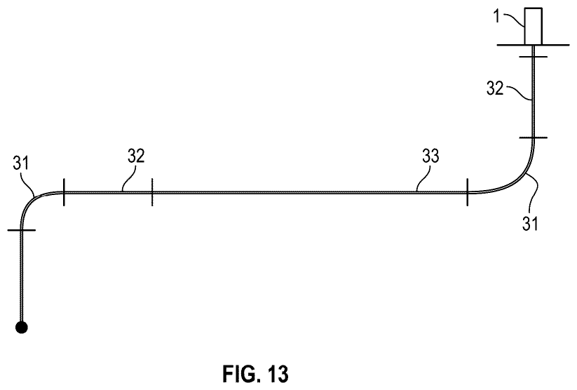

FIG. 13 is a schematic view of a vehicle (1) progressing along a path as conduit (3) is dispensed. As the vehicle (1) travels along a path, conduit dispenser (22) can operate the gripping devices (23) to disengage for certain portions of the path to reduce the wear on the gripping devices (23) and to disable their control over the conduit (3). A small error in the speed of the gripping devices (23) over longer distances can cause the conduit (3) to slide along the ground where a turn is made and either no longer be in a recoverable position when the vehicle returns or may damage crop growing around the turn. Therefore, it may be desirable to no longer grip the conduit (3) with the gripping devices (23) at certain points along a path. In one example, the gripping devices (23) may be disengaged when sufficient conduit (3) is on the ground to maintain tension on the conduit tension sensor (25) without the assistance of the gripping devices (23). As the vehicle (1) makes a turn (31) along the path in FIG. 13, the gripping devices (23) are engaged. After traveling a sufficient distance away from the turn, for example an “engaged distance” (32), the gripping devices (23) are then disengaged. The speed that the conduit continues to be dispensed is then controlled by the conduit on the ground increasing and decreasing the tension measured by the conduit tension sensor (25) which can be used to adjust the reel speed. The engaged distance (32) can be chosen by the user or determined by a control system on the vehicle (1) based on whether the conduit is full or empty as detected by a flow meter or pressure sensor measuring the presence of liquid or another agricultural input in the conduit (3). The conduit tension sensor (25) may also be used to detect if the gripping devices (23) were disengaged too early due to the tension measured by the conduit tension sensor (25) dropping after the gripping devices (23) are disengaged. This drop in tension would indicate the conduit is moving toward the vehicle and that its weight is not able to maintain the needed tension on the conduit tension sensor. The gripping devices (23) could then be reengaged until more conduit is dispensed on the ground. As the vehicle returns to the engaged distance (32) portion of the path, the gripping devices are reengaged to manage the conduit through the next turn (31). After the vehicle has recovered the conduit in the turn (31), the distance to the next turn (33) may exceed the engaged distance (32) and the gripping devices (23) may be disengaged and not reengage again until the vehicle begins to make a new turn.

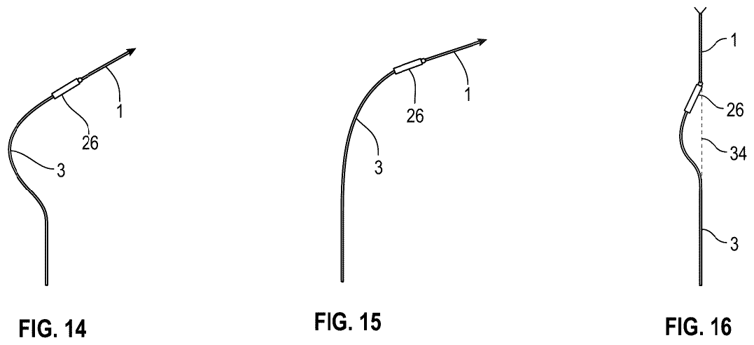

FIGS. 14 and 15 are schematic views of a path of vehicle (1), illustrating where a conduit angle sensor (26) or other sensor able to detect the position of the conduit (3) relative to the vehicle (1) may be used to adjust the speed of the gripping devices (23) to increase or decrease the speed conduit is dispensed or recovered. Comparing FIGS. 14 and 15, while conduit (3) is dispensed from the vehicle (1), the angle sensor (26) may be used to control the speed of the gripping devices (23) to position the conduit (3) on the ground at a desired location. A target position measured by the angle sensor (26) may be straight from the rear of the vehicle. During a turn, the conduit (3) may be placed outside of the turn, resulting in more conduit (3) being placed on the ground than desired. Alternatively, the target position may be more or less than straight from the vehicle (1), causing more or less conduit to be dispensed, thereby landing conduit (3) further outside or inside the turn of the vehicle (1). In some situations, it can be desirable to dispense more conduit (e.g., as shown in FIG. 14) versus less (e.g., as shown in FIG. 15) in a turn. More conduit acts a buffer if conduit is being under dispensed by the gripping devices after the turn and the conduit is slowly being pulled by the vehicle. More conduit increases the likelihood that the conduit is still in a recoverable position when the vehicle returns to a straight position.

As shown in FIG. 16, while recovering conduit (3) on a generally straight segment of path, the conduit angle sensor (26) may detect that extra conduit was dispensed or that slack in the conduit has bunched together in one area. In this situation, the conduit (3) is no longer at the desired position (34). The angle sensor (26) may then provide a signal to increase the speed of the gripping devices (23) over ground speed so as to recover conduit (3) more quickly relative to the speed of the vehicle (1) causing the extra conduit to be returned to the reel (2). Once the angle sensor (26) senses return to its target position, which may be straight relative to the travel direction of the vehicle or another angle set by the user, it then allows the gripping devices to resume turning at ground speed.

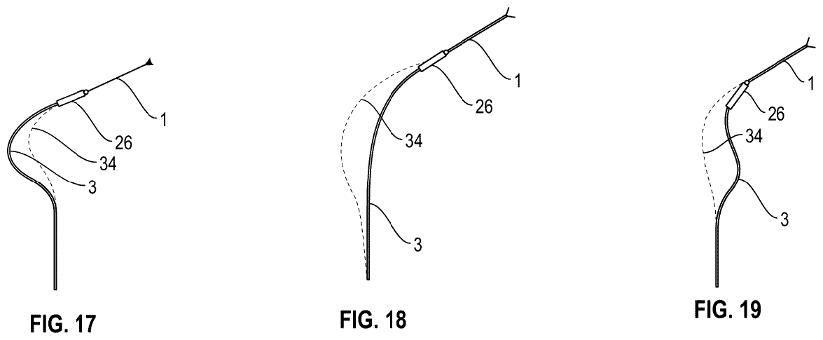

As shown in FIG. 17, while recovering conduit (3) in a turn, the angle sensor (26) may detect that the conduit is outside the turn and away from the desired position (34). The angle sensor may then increase the speed of the gripping devices (23) to greater than ground speed until extra conduit is recovered and the angle sensor returns to its target position.

As shown in FIG. 18, while recovering conduit in a turn, the angle sensor (26) may detect that the conduit (3) is inside the turn and inside the desired position (34). The angle sensor may then decrease the speed of the gripping devices (23) to less than ground speed until the conduit (3) is pushed back toward the desired position sufficiently to allow the angle sensor to return to its target position (34).

As shown in FIG. 19, while recovering conduit (3) in a turn, the angle sensor (26) may detect that the conduit (3) is inside the turn and inside the desired position (34). The angle sensor (26) may then decrease the speed of the gripping devices to less than ground speed to attempt to push the conduit (3) back to the desired position (34). In some cases as shown in FIG. 19, the shape of the conduit (3) on the ground may cause it to move further away from the desired position (34). The angle sensor (26) will detect that it is being moved further away from its target position (34) and may then increase the speed of the gripping devices to pull the conduit (3) into a better shape to allow for it to be pushed to the target position (34). After the angle sensor (26) detects its position is moving towards its target, it may again reduce the speed of the gripping devices (23) to attempt to push the conduit to its desired position. It may slow or stop the movement of the vehicle (1) if more time is needed to detect an improvement in the angle sensors (26) position relative to target. If it is unsuccessful, the conduit (3) may push the angle sensor to a stop limit, either set by the user or set as the angle where the conduit (3) will be kinked or damaged if pulled through the dispenser. The user may then be alerted to manually move the conduit (3) to the desired position and restart the vehicle. A “dead band” range about the target position of the angle sensors (26) may be used to allow for small motion of the conduit while it is being dispensed or recovered without the angle sensor changing the speed of the gripping devices. The dead band range may be set by the user.

The speed that the gripping devices turn to attempt to match ground speed of the vehicle may be adjusted over time by analyzing an amount of time that the angle sensor signaled to increase or decrease the speed of the gripping devices while recovering one or more of the previous turns. For example, if more time was spent during a turn with the angle sensor detecting the conduit inside the turn, this situation would indicate that the speed of the gripping devices is less than actual ground speed, thereby causing the conduit to follow the vehicle and pulling the conduit inside the turn. If on the other hand more time was spent during the turn with the angle sensor detecting the conduit outside the turn, this would indicate that the speed of the gripping devices is more than actual ground speed, thereby causing the conduit to move away from the vehicle and pushing the conduit outside the turn. Based on the behavior of the angle sensor over one or more previous turns, the speed of the gripping devices relative to ground speed may then be adjusted so that performance measured for one or more future turns and adjusted again. The speed of the gripping devices relative to ground speed may also be adjusted to minimize the current used by the motor turning the gripping devices while the vehicle is moving straight. Reducing the current will ensure that the gripping devices do not pull or push the conduit on the ground and therefore turn at the correct speed relative to ground speed.

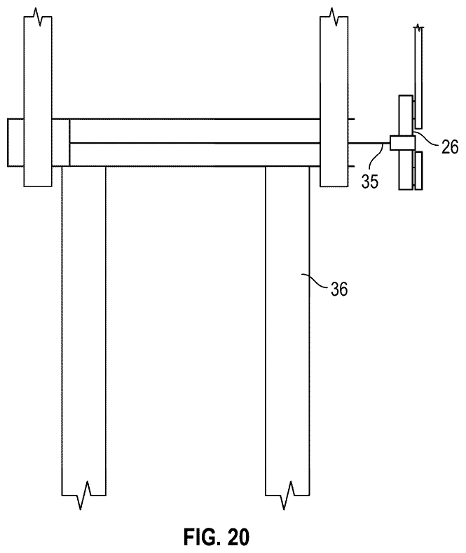

In a further embodiment shown in FIG. 20, a sensor, herein shown as angle sensor (26) may be mounted to a flexible shaft (35) connected to an arm (36) contacting the conduit. Those skilled in the art will appreciate that any sensor can be mounted to the flexible shaft (35), such as a conduit tension sensor or other rotational sensor on the vehicle (1). The relative alignment of the arm (36) and angle sensor (26) can be shifted slightly and still function due to the flexibility of the shaft (35). However, rotation of the arm (36) is transferred directly through the shaft (35) to be measured by the angle sensor (26).

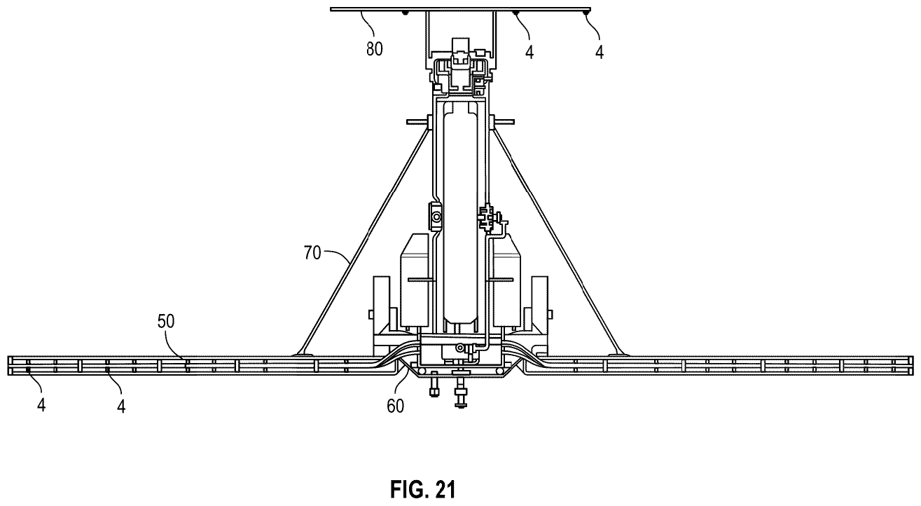

As shown in FIG. 21, application devices such as liquid drops (4) may be positioned at different locations on the vehicle (1). In one embodiment, application devices (4) may be mounted to a primary boom (50). The primary boom (50) may be mounted to the rear of the vehicle (1) (as viewed in a direction of travel of the vehicle) as shown in FIG. 21 or mounted on the front or from the sides of the vehicle (1). Portions of the boom (50) may be mounted to pivot points (60) to allow the boom (50) or portions thereof to be folded along the vehicle for a narrower transport width. Boom supports (70) may be mounted between a boom (50) and the vehicle (1) to support the boom as it experiences wind forces or other forces generated by contacting a crop. A secondary boom (80) may be mounted in a second location on the vehicle (1). As shown in FIG. 21, secondary boom (80) is mounted to the front of the vehicle (1) while primary boom (50) is mounted to the rear of the vehicle (1). Application devices (4) may then be mounted to any boom (e.g., booms 50 and/or 80), to boom supports (7), or to a frame of the vehicle (1). Application devices (4) may be positioned along the booms and vehicle to provide complete coverage of the ground passing under the vehicle, positioned above individual rows of a crop, or positioned between rows of a crop to deliver agricultural input.

Inputs may be applied from all application devices while traveling in both directions to maximize the amount of input that can be applied. To apply these inputs, the vehicle can reverse across ground that has already been covered with an input, which may cause rutting and mud to be picked up by the tires during the reverse pass. In one embodiment, a user of the vehicle (1) may choose to only turn on the application input source supplying the conduit (3) while the vehicle (1) is reversing to reduce the risk of rutting. Alternatively, some application devices may be turned on while driving forward and others used when reversing. For example, application devices that will apply near the tires of the vehicle may be mounted to a front boom (80), application devices away from the tires mounted to a rear boom (50). In some instances, a valve can be positioned to direct flow from the conduit (3) to one boom or the other, or to both booms simultaneously. For example, while the vehicle (1) drives forward, the valve is turned to direct flow to the rear boom (50) and to the application devices (4) away from the tires. Then, as the vehicle (1) starts to reverse, the valve is turned to direct input to the front boom (80). In this way, the ground or crop will receive a full amount of the input while the vehicle is able to drive on ground that has not yet been covered with an input.

In another embodiment, individual tubes may be used to connect each application device to a central manifold. Control valves may be placed at any point between the application device and the manifold to allow the vehicle to selectively control the flow of input through each application device. The rate applied through each device could then be varied and application devices near the tires shut off as the vehicle drives in one direction and turned on when the vehicle drives in the opposite direction.

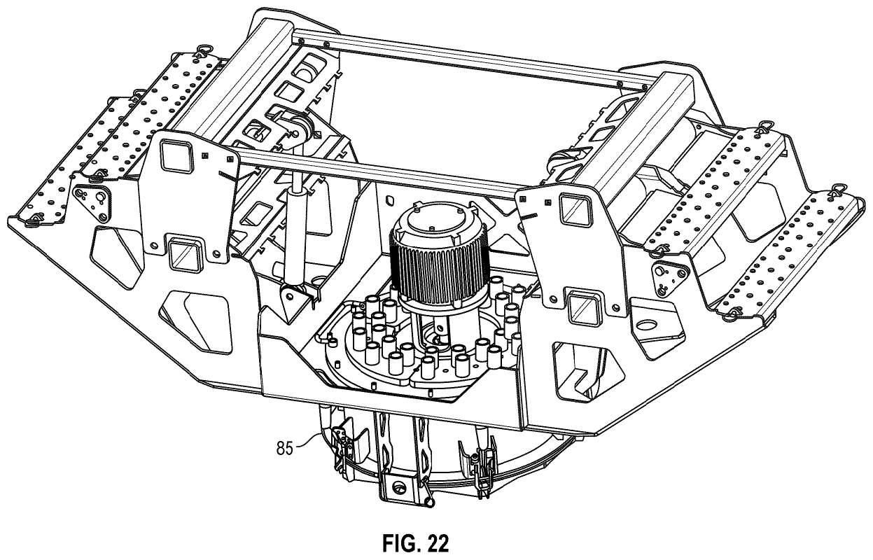

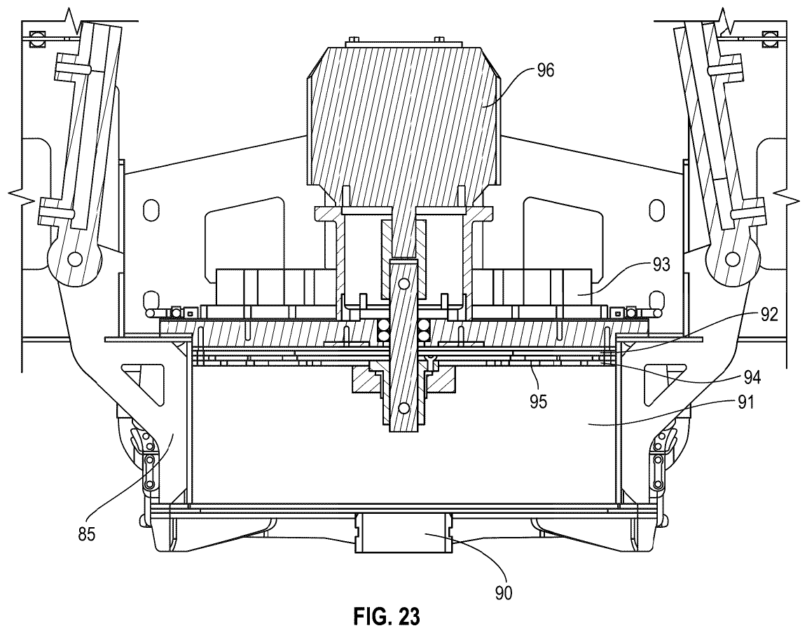

As shown in FIGS. 22-24, a liquid manifold (85) may be used to divide flow into individual conduits routed around the vehicle to specific application devices. Flow from the conduit (3) may be routed into the liquid manifold (85) through an inlet (90) at the bottom where it is held in the manifold chamber (91). Chamber (91) allows any large or heavy objects that may not pass through the manifold to settle to the bottom until they can later be removed by the user. Flow may then pass through an orifice plate (92) to be divided into individual outlets (93) connected to application devices. Optionally, flow may first be passed through a stationary shear plate (94). A shear blade (95) is sandwiched between the shear plate (94) and the orifice plate (92) and spun by an actuator such as an electric motor (96). Any object large enough to plug an orifice in the orifice plate (92) that is being carried in the flow of the input will then be sheared by the shear blade (95) and downsized to pass through the orifice. The surface of the orifice plate (92) is near the shear blade (95) so that the motion of the blade will push off any object that may bridge across the orifice and restrict flow.

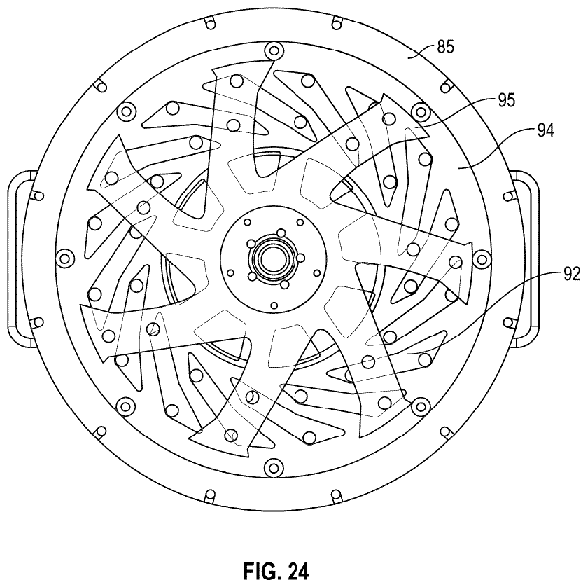

FIG. 24 is a bottom view of liquid manifold (85) showing the shear plate (94), shear blade (95), and orifice plate (92). The shear blade (95) includes a plurality of blades radiating from a central hub. Edges of the shear blade (95) and shear plate (94) may be sharpened to improve cutting. Shear blade (95) and shear plate (94) may be made of a hardened steel and/or include edges coated with a hardened material such as hard face welding or laser applied tungsten carbide to increase the wear life of the shearing surfaces.

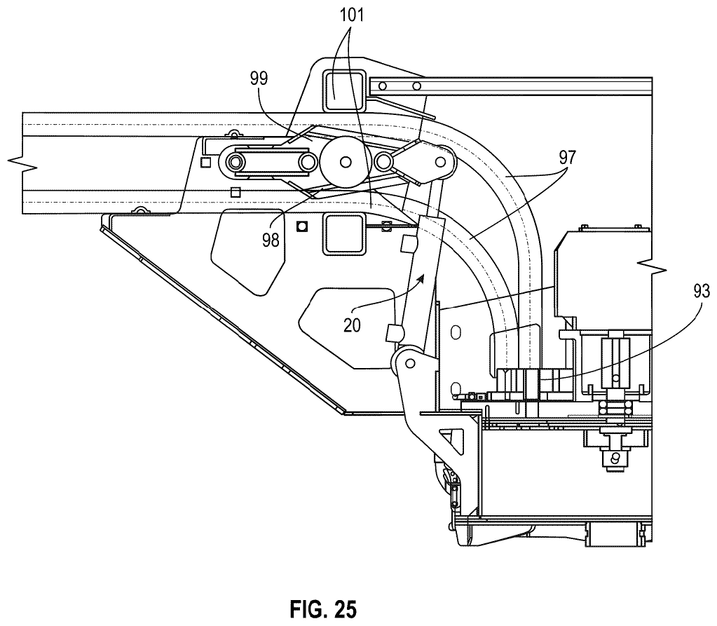

As illustrated in FIG. 25, tubes (97) connecting individual outlets (93) to application devices may be positioned to pass through a shutoff point to control flow of input from the manifold (85) to one or more application devices. In one embodiment, the shut off point may be a roller (98) positioned on a rotatable frame (99) connected to an actuator (100) (e.g., a hydraulic cylinder). The tubes (97) may be made of a rubber soft enough to be squeezed shut when compressed between the roller and an opposing surface (101) (e.g., a tube positioned adjacent to the tubes (97)). Application devices may then be grouped together so that one group is on while the other is off. For example, a group of application devices away from the tires of the vehicle may be plumbed through tubes positioned together above the roller and a group of application devices near the tires may be plumbed through tubes positioned together under the roller. As the vehicle (1) moves forward, the actuator (100) pulls the roller (98) down and squeezes the lower rubber tube (97) so that no flow passes through the lower rubber tube (97) and the application devices near the tires are off while those away from the tires (e.g., as supplied by the upper rubber tube (97)) are on. As the vehicle (1) reverses across the same ground, the actuator (100) then pushes the roller up against the upper tube (97) and those application devices away from the tires are shut off while those near the tires (e.g., as supplied by the lower rubber tube (97)) are allowed to apply. Alternatively, the roller (98) may be positioned in the middle (as illustrated in FIG. 25) to not shut off any tubes and all application devices may be allowed to flow.

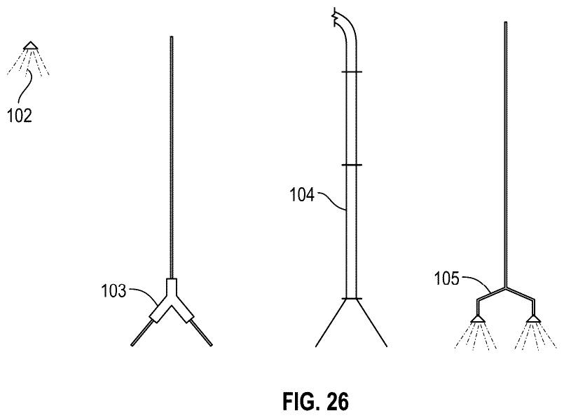

As shown in FIG. 26, application devices may vary. In one embodiment, an atomizing nozzle (102) may be used to apply on the ground or a crop. In another embodiment, a single tube may be split into two outlets through a splitter (103) to direct flow towards rows of a crop. Alternatively, two tubes (104) may be routed together from a source and diverge near the ground to direct flow towards rows of a crop. Objects being carried in the flow of an input may plug in a splitter or atomizing nozzle, so routing multiple tubes from a source with no splitter may be preferred when an input such as livestock manure is being applied. In another embodiment, a tube may be split into two atomizing nozzles or two fan outlets (105) to apply an even coverage of an input across the ground from a single tube.

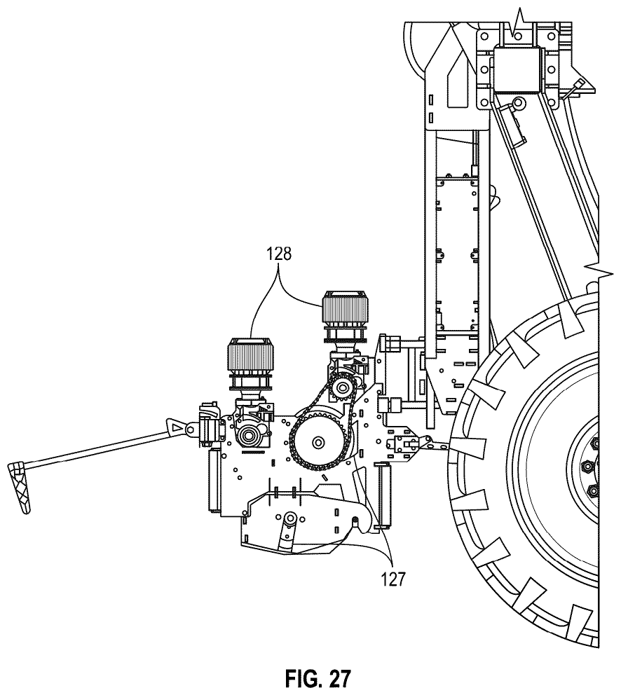

As shown in FIG. 27, in an alternative embodiment of a conduit management assembly, each gripping device (127) may be independently driven by an actuator (128) such as an electric motor or hydraulic motor. In some embodiments, the gripping device (127) is driven by a chain attached to a gearbox driven by an electric motor. A first gripping device may be turned so that its outer radius is rotating at a target speed to dispense or return the tube from or to the vehicle at a speed equal and opposite the speed of the vehicle. Additionally, the speed of the first gripping device may be further adjusted to match a load target such as a motor current target to ensure sufficient grip is being produced by the first gripping device. The speed of the second gripping device may then be adjusted so that the power produced by each actuator is approximately equal to the power produced by the actuator driving the first gripping device. For example, if the actuators are electric motors, the speed of each gripping device should be adjusted so that the current drawn by each motor is approximately equal to the current drawn by the first motor. In this way, forces produced on the conduit (3) are approximately equal at each gripping device even if the effective radius of each varies.

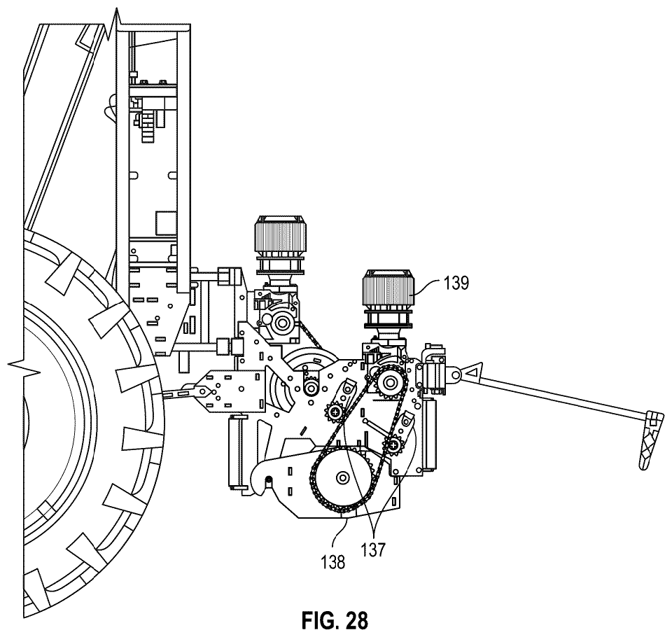

Similar to use of linear actuators 27 in FIGS. 11 and 12, in an alternative embodiment of a conduit management assembly shown in FIG. 28, one or more chain tension sensors (137) may be positioned along a chain driving a first gripping device (138). To disengage the gripping devices, the speed of first actuator (139) is adjusted so one or more chain tension sensors (137) move to a neutral position. The neutral position indicates that the first gripping device (138) is rotating by first actuator (139) at a speed equal or nearly equal to movement of the conduit passing through the gripping devices. As a result, little or no force is transferred from the first gripping device (138) to the conduit. If two chain tension sensors (137) are used as shown in FIG. 28, the neutral position is when each is balanced with an equal amount of chain slack on both sides. The speed of any other gripping device is then adjusted as described previously so that the force produced by all gripping devices is approximately equal. To reengage the gripping devices, the speed of the first actuator (139) is increased to its original target, the desired side of the chain will become loaded and seen in the measurement of the chain tension sensors (137), and the speed of other gripping devices will be increased to match the force applied by the first gripping device (138). The chain tension sensors (137) can thus be used in a similar manner along a path as described with respect to FIG. 13.

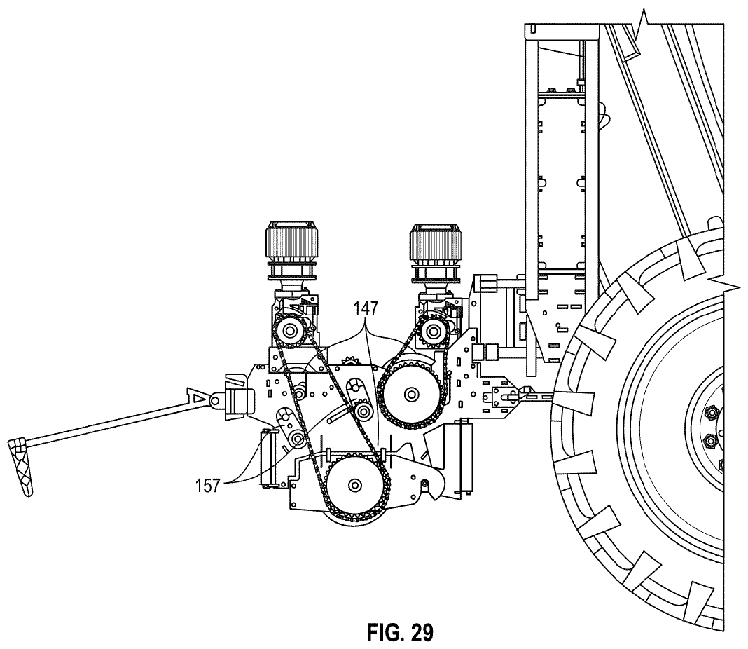

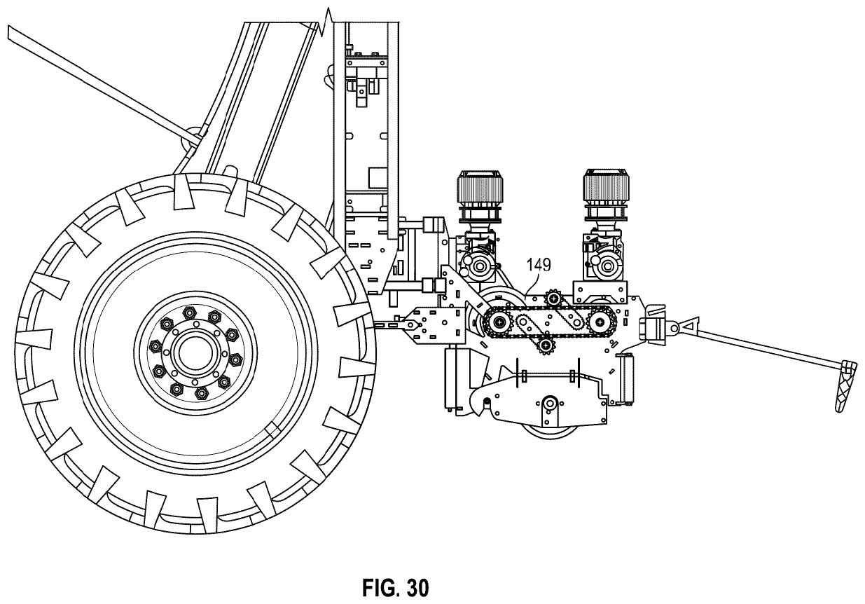

In a further embodiment of a conduit management assembly shown in FIGS. 29 and 30, three gripping devices (147) are used. The bottom gripping device is treated as the first gripping device. Chain tension sensors (157) are used to engage and disengage the force applied by the first gripping device. Two top gripping devices are connected with a chain (149) and treated as one device driven by a single actuator for the purpose of load balancing with the bottom first gripping device. The distance between the axis of the bottom gripping device and the two on the top is set so that the conduit experiences three point bending as it passed through the conduit management assembly. Maintaining three-point bending increases the grip on the conduit and enables the conduit management assembly to create more tension on the conduit on the reel before the conduit slips past the gripping devices.

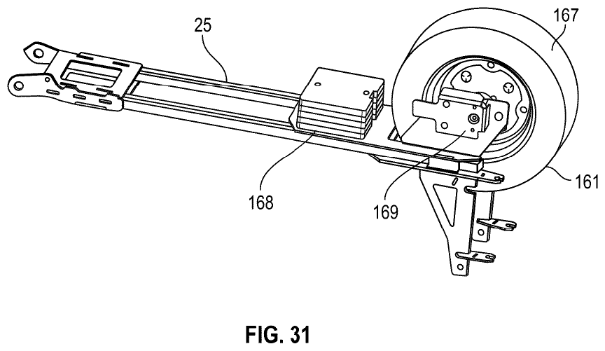

As illustrated in FIG. 31, a conduit displacement sensor assembly (161) may be used to measure the amount of conduit (3) being dispensed off or retrieved onto the vehicle (1) and used to adjust the speed of one or more elements of an associated conduit management assembly so that the length of conduit dispensed or retrieved is equal to the distance traveled by the vehicle (1) over time.

Conduit displacement sensor assembly (161) includes a measuring wheel (167) that is held in contact with the conduit (3) passing beneath the measuring wheel (167). In this example, the measuring wheel (167) is mounted at one end of the conduit tension sensor (25). Added weights (168) may be used to ensure good grip between the wheel and the conduit. A rotary sensor (169) such as a speed or angle sensor is positioned to measure the revolutions of the measuring wheel as it is turned by the movement of the conduit. The diameter of the measuring wheel may be measured by the user and given to the control system reading the rotary sensor to convert the revolutions of the wheel into a length of conduit dispensed or retrieved. Other sensors on the vehicle (1) such as a global positioning sensor or wheel speed sensor may be used by a vehicle control system to calculate the distance travelled by the vehicle (1). The vehicle control system may then compare the measured length of conduit dispensed or retrieved with the distance travelled by the vehicle and adjust the speed of the dispenser up or down to correct any error between the two.

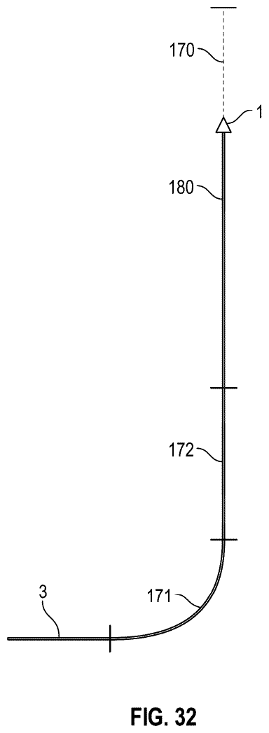

With reference to FIG. 32, a diameter calculation of the measuring wheel may be automatically calibrated by a vehicle control system at certain points along a path (170) of the vehicle (1). The vehicle path (170) may include a turn zone (171), a displacement control zone (172), and a calibration zone (180). During the turn zone (171), a conduit angle sensor may be used to control the dispenser as described in this application. During the displacement control zone (172), the speed of the dispenser may be controlled using a conduit displacement sensor as described above. A minimum length of the displacement control zone should be set so that the weight of the conduit (3) on the ground is sufficient to allow the reel (2) to meet a tension target position of the conduit tension sensor without dragging the conduit (3) along the ground while the gripping devices of the dispenser are disengaged as described previously in this application.

During the calibration zone (180), the gripping devices can be disengaged, and the vehicle control system can assume that the conduit (3) is stationary on the ground. As the vehicle (1) travels through the calibration zone (180), the control system compares the measured length of conduit (3) from the measuring wheel using the current calculated diameter to the distance traveled by the vehicle. The diameter calculation of the measuring wheel (167) is then adjusted to correct for any error between the two.

As the vehicle (1) enters the displacement control zone (172), the gripping devices in the dispenser are reengaged and the last diameter calculation of the measuring wheel (167) is registered and used as the vehicle control system adjusts the speed of the dispenser to correctly dispense or retract the right amount of conduit (3) for the distance travelled by the vehicle.

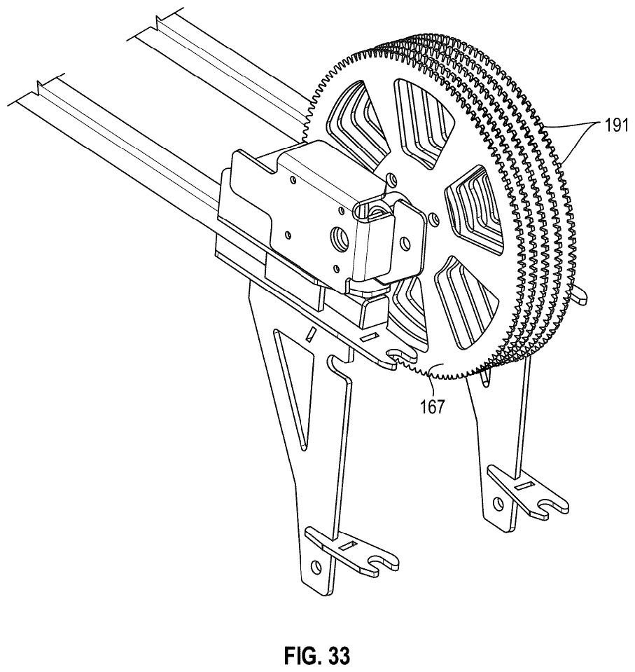

In one embodiment shown in FIG. 33, the measuring wheel (167) may include spikes (191) along its edge to engage with the conduit and minimize or prevent slip from occurring between the conduit (3) and the measuring wheel (167). In another embodiment, the measuring wheel (167) may be made of a stiff rubber material so that the diameter of the measuring wheel remains constant and is slip resistant.

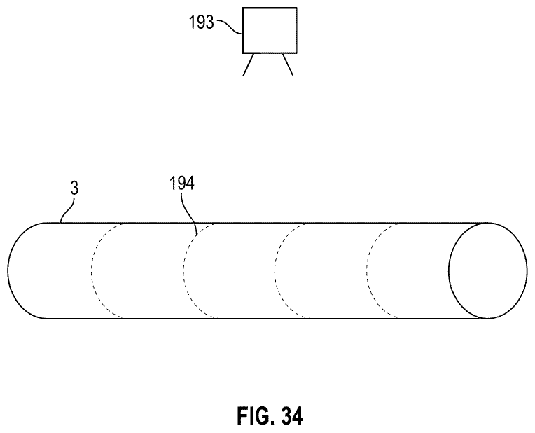

In a further embodiment shown in FIG. 34, an alternative conduit displacement sensor assembly may include an optical sensor (193) such as a non-contact camera positioned to view the conduit (3). Marks or indicia (194) may be added to the conduit (3) at a consistent spacing. The sensor (193) may then be used to detect the number of marks passing through a viewing window in a period of time to determine the length of conduit being dispensed or retracted. In another embodiment, the sensor may be positioned to view the conduit on the ground and detect relative motion between the conduit and the ground by identifying unique features on the ground and the conduit and looking for motion between them.

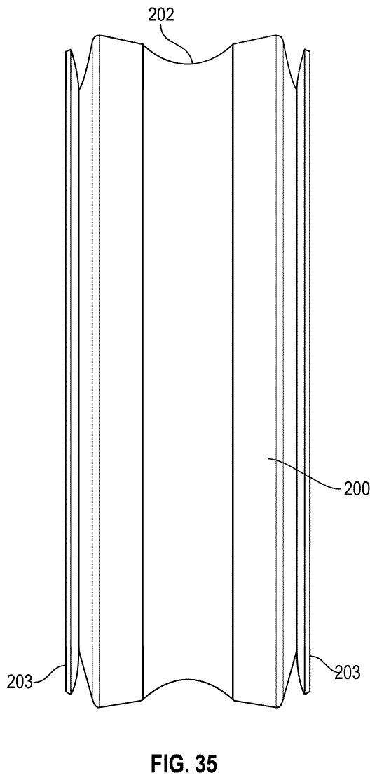

As shown in FIG. 35, one embodiment of a gripping device (200) may be a rubber tire mounted to a rim. The rubber tire may have a concave profile (202) so that the conduit is naturally centered as it is gripped by the gripping device (200). The rim may include side supports (203) positioned along the sides of the tire to increase the grip of the rim on the tire and to increase the compressive force applied through the tire to the conduit.

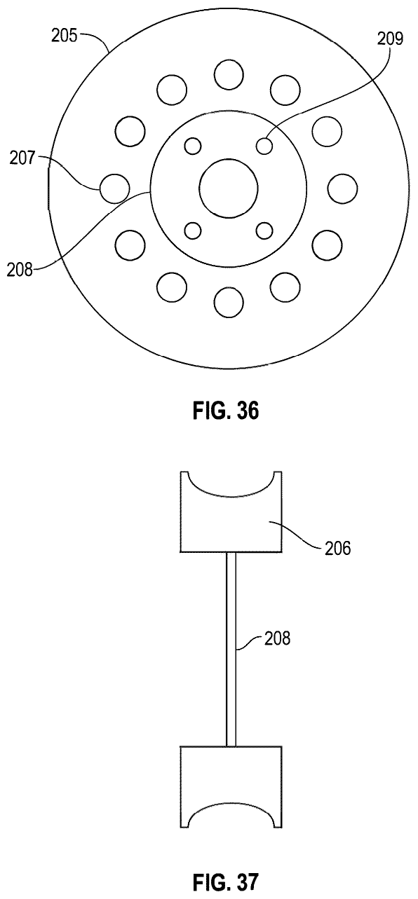

In an alternative embodiment as shown in FIGS. 36 and 37, a molded wheel (205) made from a material such as polyurethane may be used as the gripping devices in the dispenser. The outer profile (206) of the wheel (205) may be concave shaped to cause the conduit to be naturally centered as it passes through the conduit management assembly. The middle of the wheel (205) may include flexures or cores (207) that are removed from the outer profile (206) to impart flexibility into the molded wheel (205) and allow it to adjust its diameter to remain in contact with the conduit as the shape of the conduit changes. In some examples, the cores (207) are circular shaped but may be other combinations of shapes to form a flexible web of connections between the outer edge of the wheel and the center. The wheel (205) may be bonded to a steel rim (208) so that torque is transferred from the rim to the outer edge of the molded wheel (205). The rim (208) may include mounting features (209) such as holes positioned to allow the tire to be mounted on a shaft in the dispenser.

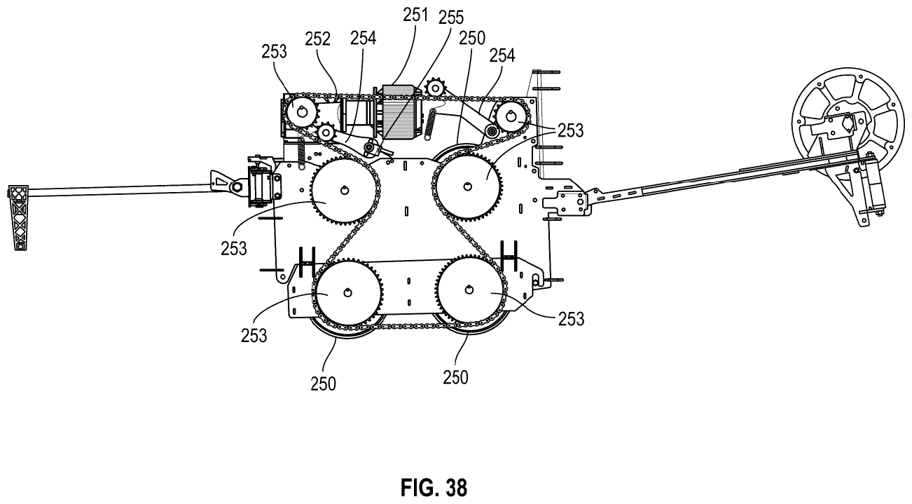

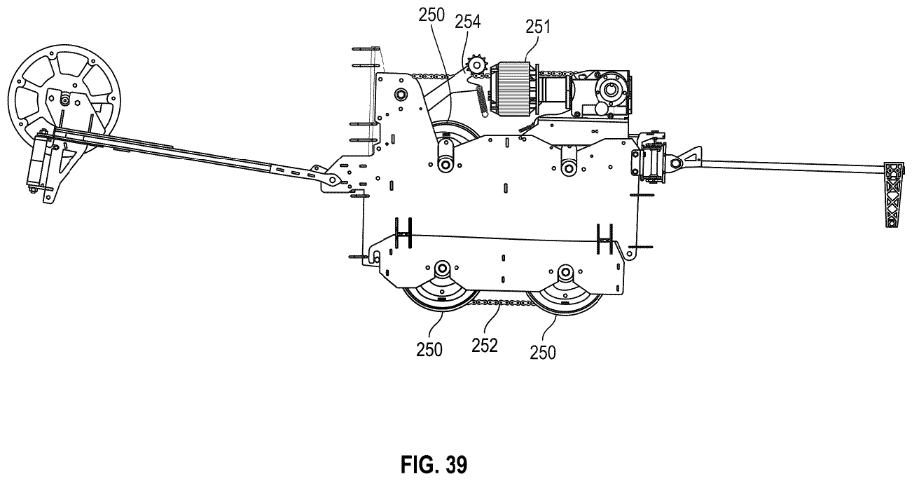

In FIGS. 38 and 39, another embodiment of a conduit management assembly is shown with four gripping devices (250). The four gripping devices (250) are powered by an actuator (251) (herein an electric motor and gearbox) driving a chain (252) routed to drive all gripping devices in the same direction through sprockets (253). One or more chain tensioners (254) are positioned to maintained tension on the chain (252) as the gripping devices (250) are turned in either direction. A chain tension sensor (255) is used to measure the position of one of the tensioners and allow the dispenser to be disengaged as described in the application. The chain (252) and sprockets (253) can be covered with a shield (not shown) in one embodiment. In another embodiment, the chain (252) and sprockets (253) can be contained in a sealed oil bath chamber (not shown) to improve the wear life of the chain by lubrication.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A fluid distribution system for a crop application vehicle, comprising:
a manifold connected to an agricultural input source;
a plurality of tubes connected to outlets of the manifold, each of the plurality of tubes including an air ingestion chamber;
a plurality of application devices connected to each of the plurality of tubes, each of the plurality of application devices terminating at an application point; and
a control assembly connected with each air ingestion chamber and configured to control flow of agricultural input through one or more of the plurality of tubes.

2. The fluid distribution system of claim 1, further comprising a sensor coupled with each air ingestion chamber, each sensor coupled with the control assembly.

3. The fluid distribution system of claim 1, further comprising a check valve coupled with each air ingestion chamber, each check valve operable to control flow through a respective one of the plurality of tubes.

4. The fluid distribution system of claim 1, wherein the manifold includes an orifice plate, a shear plate and a shear blade positioned between the orifice plate and the shear plate.

5. The fluid distribution system of claim 4, further comprising a motor configured to operate the shear blade.

6. The fluid distribution system of claim 1, wherein the control assembly includes a roller and an actuator coupled with the roller, the actuator configured to adjust a position of the roller to prevent flow through at least one of the plurality of tubes.

7. The fluid distribution system of claim 6, wherein the actuator pivots the roller to different positions relative to a frame.

8. The fluid distribution system of claim 7, wherein the actuator is a hydraulic cylinder.

9. The fluid distribution system of claim 1, wherein at least one of the application points includes a splitter defining a bottom wall to receive agricultural input and divert the agricultural input to outlets on either side of the bottom wall.

10. The fluid distribution system of claim 9, wherein at least one of the outlets includes an extension defining a plug and an extension outlet adjacent the plug.

11. The fluid distribution system of claim 1, wherein at least two of the plurality of tubes are of different length and wherein the control assembly is configured to balance flow between said at least two of the plurality of tubes.

12. An application vehicle, comprising:
a vehicle frame supported by wheels driving the application vehicle along a direction of travel;
a reel supported by the vehicle frame, said reel supporting a conduit such that the conduit can be extended from or retracted onto said reel, said conduit configured to be connected to an agricultural input source;
a manifold fluidly connected to the conduit;
a plurality of tubes connected to outlets of the manifold, each of the plurality of tubes including an air ingestion chamber;
a plurality of application devices connected to each of the plurality of tubes, each of the plurality of application devices terminating at an application point; and
a control assembly connected with each air ingestion chamber and configured to control flow of agricultural input through one or more of the plurality of tubes.

13. The application vehicle of claim 12, further comprising:
a first application boom coupled to the application vehicle at a first position with respect to the direction of travel; and
a second application boom coupled to the application vehicle at a second position with respect to the direction of travel;
wherein application devices connected to the first application boom are configured to deliver agricultural input while the application vehicle travels in the direction of travel and wherein application devices connected to the second application boom are configured to deliver input while the application vehicle travels in a direction opposite the direction of travel.

14. A conduit management assembly for controlling a length of conduit dispensed from or retracted onto an application vehicle, comprising:
a plurality of gripping devices having the conduit positioned therebetween;
an actuator configured to provide a rotational output; and
a chain configured to translate the rotational output of the actuator to at least one of the plurality of gripping devices.

15. The conduit management assembly of claim 14, further comprising a cleaning system configured to clean substances from at least one of the plurality of gripping devices and the conduit.

16. The conduit management assembly of claim 14, wherein each of the plurality of gripping devices include a concave profile configured to engage the conduit.

17. The conduit management assembly of claim 14, wherein the plurality of gripping devices includes at least three gripping devices.

18. The conduit management assembly of claim 14, further comprising a chain tension sensor configured to detect a tension on the chain.

19. The conduit management assembly of claim 14, wherein at least two of the plurality of gripping devices are connected by the chain.

20. The conduit management assembly of claim 14, further comprising a conduit displacement sensor assembly configured to calculate an amount of conduit dispensed from the application vehicle.

21. The conduit management assembly of claim 20, wherein the conduit displacement sensor assembly includes a rotatable measuring wheel contacting the conduit.

22. The conduit management assembly of claim 21, wherein the rotatable measuring wheel includes spikes configured to engage the conduit.

23. The conduit management assembly of claim 20, wherein the conduit displacement sensor assembly includes an optical sensor positioned to detect a position of the conduit.

24. The conduit management assembly of claim 23, wherein the conduit includes indicia detectable by the optical sensor.

25. The conduit management assembly of claim 14, wherein each of the plurality of gripping devices include cores that impart flexibility into the plurality of gripping devices.

26. The conduit management assembly of claim 14, wherein each of the plurality of gripping devices is formed of molded rubber.

27. The conduit management assembly of claim 14, wherein the plurality of gripping devices include four gripping devices.

28. The conduit management assembly of claim 14, wherein the chain is connected to each of the plurality of gripping devices.
